(19) United States
(12) Patent Application Publication
(10) Pub. No.: US 2010/0285787 A1
(43) Pub. Date: Nov. 11, 2010

(54) Telephone directory data memory device having near field communication function and method for managing telephone directory data

(75) Inventor: Naoki Matsuda, Anjo-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/799,973

(22) Filed: May 5, 2010

(30) Foreign Application Priority Data
May 11, 2009 (JP) 2009-114554

(51) Int. Cl. H04M 3/00

(52) U.S. Cl. 455/418

(57) ABSTRACT

A telephone directory data memory device includes: a communication line connecting element for coupling with a cell phone having a telephone directory data; a memory for storing the telephone directory data; a controller for controlling a memory status of the telephone directory data in the memory; and a telephone number obtaining element for obtaining a new telephone number of a new cell phone. The memory stores a correspondence relationship between the ,telephone number and the telephone directory data. The controller controls the memory to maintain the correspondence relationship when a first predetermined condition is met in a case where the telephone directory data is stored in the memory. The first predetermined condition is met when a first operation input element receives a first operation of the user.

### CROSS REFERENCE TO RELATED APPLICATION

This application is based on Japanese Patent Application No. 2009-114554 filed on May 11, 2009, the disclosure of which is incorporated herein by reference.

### FIELD OF THE INVENTION

The present invention relates to a telephone directory memory device having near field wireless communication function with a cell phone, and a method for managing a telephone directory data in a memory device having a near field wireless communication.

### BACKGROUND OF THE INVENTION

A cell phone stores telephone directory data, and the data is transmitted from the cell phone to an in-vehicle device. Thus, the in-vehicle device stores the telephone directory data transmitted from the cell phone. This device is disclosed in JP-A-2003-198713 corresponding to US Pub. No. 2003/0114202.

When the in-vehicle device is coupled with the cell phone via a Bluetooth (i.e., BT) wireless communication line, the in-vehicle device manages information in view of security such that the in-vehicle device links the telephone directory data with a BT device address. Here, Bluetooth is a registered trademark.

It is necessary for a user of the device to preliminary register an address of the cell phone as the other side of connection in order to couple between the in-vehicle device and the cell phone with the BT communication line. When a model of the cell phone is replaced to a new model, i.e., when the cell phone is replaced with a new one although a service contract and a telephone number are not changed, it is necessary to newly register the cell phone after the model of the phone is replaced to the new model even though the cell phone before the model of the phone is replaced is registered as the connection other side in the in-vehicle. Thus, when the in-vehicle device manages information to link the telephone directory data with the BT device address, the following difficulties may generate.

Specifically, the user changes the model of the cell phone having a BT communication function with a new model, and the user newly registers the new model cell phone as the connection other side, the BT device address of the previous model cell phone may be different from the BT device address of the new model cell phone. When the BT device address of the previous model is different from the BT device address of the new model, the. BT device address does not link with the telephone directory data. Accordingly, although the telephone directory data is available before the model of the cell phone is changed, the telephone directory data is not available after the model of the cell phone is changed.

### SUMMARY OF THE INVENTION

In view of the above-described problem, it is an object of the present disclosure to provide a telephone directory memory device having near field communication function with a cell phone. It is another object of the present disclosure to provide a method for managing a telephone directory data in a memory device having a near field wireless communication. Even when a model of the cell phone is replaced with a new model cell phone, telephone directory data is available.

According to a first aspect of the present disclosure, a telephone directory data memory device having a near field wireless communication function includes: a communication line connecting element for coupling with a cell phone via a near field wireless communication line, wherein the cell phone stores a telephone directory data; a memory for storing the, telephone directory data, which is transmitted from the cell phone; a controller for controlling a memory status of the telephone directory data in the memory; and a telephone number obtaining element for obtaining a new telephone number of a new cell phone when the new cell phone is registered as a connection object device of the communication line connecting element. The new telephone number of the new cell phone is equal to a telephone number of the cell phone. The memory connects the telephone number of the cell phone and the telephone directory data, and stores a correspondence relationship between the telephone number and the telephone directory data. The controller controls the memory to maintain the correspondence relationship between the telephone number and the telephone directory data when a first predetermined condition is met in a case where the telephone directory data corresponding to the telephone number is stored in the memory.

Although a conventional device manages a correspondence relationship between a BT device address and a telephone directory data, the above device manages the correspondence relationship between the telephone number and the telephone directory data. Thus, even when the user changes a model of the cell phone, the telephone directory data that is available before the model is changed is continuously available after the model is changed.

According to a second aspect of the present disclosure, a method for managing a telephone directory data in a memory device having a near field wireless communication function includes: searching a cell phone having a near field wireless communication function around the memory device; connecting the memory device and the cell phone via a near field wireless communication line; obtaining a telephone number and a telephone directory data stored in the cell phone, and storing a correspondence relationship between the telephone number and the telephone directory data in the memory device; inquiring of an user of the memory device whether the telephone directory data is available when a new cell phone is searched, and the telephone directory data corresponding to a new telephone number of the new cell phone is stored in the memory device; and maintaining the correspondence relationship between the new telephone number and the telephone directory data when the user selects that the telephone directory data is available.

Although a conventional device manages a correspondence relationship between a BT device address and a telephone directory data, the above device manages the correspondence relationship between the telephone number and the telephone directory data. Thus, even when the user changes a model of the cell phone, the telephone directory data that is available before the model is changed is continuously available after the model is changed.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an in-vehicle hands-free system;

FIG. 2 is a diagram showing memory region of telephone directory data in a memory;

FIG. 3 is a diagram showing a register process of a cellphone;

FIG. 4 is a flow chart showing telephone directory data management process;

FIG. 5 is a diagram showing one example of changes of the telephone directory data before registration and after registration;

FIG. 6 is a diagram showing another example of changes of the telephone directory data before registration and after registration; and

FIG. 7 is a diagram showing another example of changes of the telephone directory data before registration and after registration.

### DETAILED DESCRIPTION OF THE PREFERRED EMBODIMENTS

An in-vehicle hands-free device having a BT communication function as one example of a telephone directory data memory device having a near field communication function according to an example aspect of the present disclosure will be explained. Here, the in-vehicle hands-free device is mounted on a vehicle, and a cell phone having the BT communication function is disposed in a compartment of the vehicle. Thus, the hands-free device is capable of communicating with the cell phone with the BT communication line.

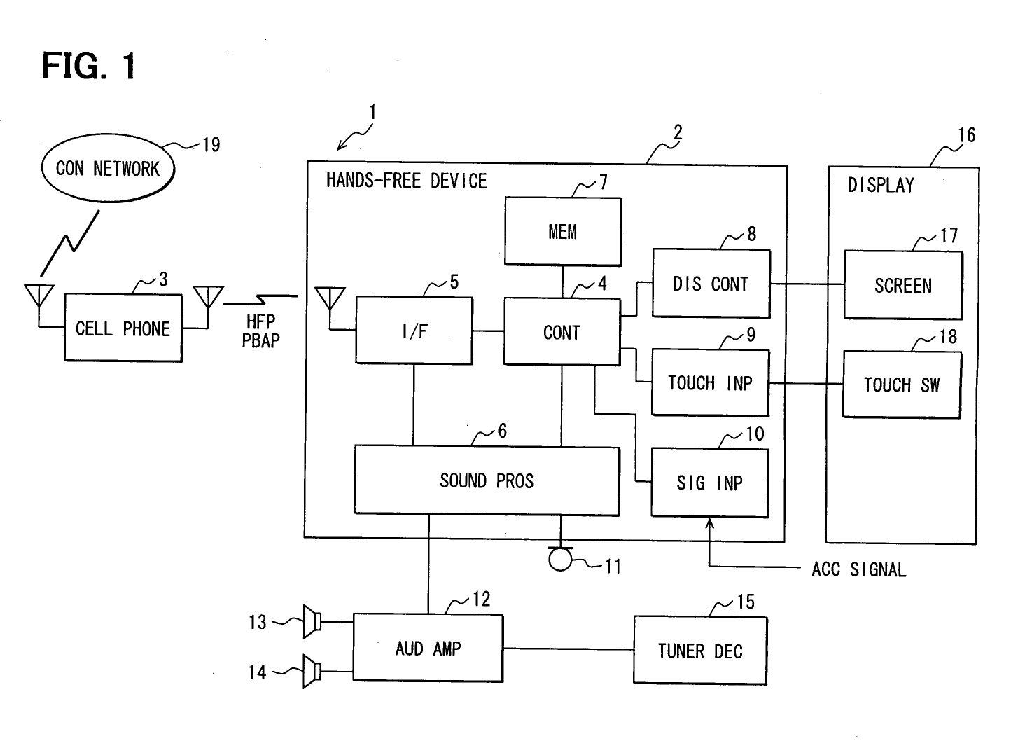

FIG. 1 shows an in-vehicle hands-free system 1. The system 1 includes an in-vehicle hands-free device 2 having the BT communication function and a cell phone 3 having the Bt communication function. The hands-free device 2 includes a controller 4 as a control element, a telephone number obtaining element, a telephone directory data obtaining element, and first to third operation instruction receivers. Further, the device 2 includes a BT interface (IF) 5 as a communication line connection element, a communication sound processing element 6, a memory 7 as a telephone directory data memory, a display controller 8, a touch operation input element 9 and a signal input element 10.

The controller 4 includes a CPU as a conventional microcomputer, a RAM, a ROM, an I/O bus and the like. The controller 4 controls all operations in the hands-free device 2 such as communication function and information management function. The BT interface 5 performs the BT communication function with the cell phone 3. Specifically, when the cell phone 3 is coupled with the device 1 via the BT wireless communication line as a near field wireless communication line, a hands-free profile (i.e., HFP) for performing hands-free communication and a phone book access profile (i.e., PBAP) for performing data transfer of the telephone directory data are executed. The HFP and the PBAP are defined by BT communication standards, and each profile is communication protocol defined in a corresponding function. In this case, the BT interface 5 may be coupled with the cell phone 3 with executing multiple profiles simultaneously so that the interface 5 executes a multiple coupling function. Alternatively, the interface 5 may be coupled with the phone 3 without executing multiple profiles simultaneously.

The communication sound processing element 6 is coupled with a microphone 11, which is arranged at a predetermined place such as a place near a steering wheel in the compartment of the vehicle so as to collect voice of the user easily and effectively. Further, the element 6 is coupled with an audio amplifier 12, which is arranged on the outside of the hands-free device 2. The audio amplifier 12 is coupled with two speakers 13, 14. One speaker 13 is arranged on a driver seat side door, and the other speaker 14 is arranged on a front passenger seat side door. The audio amplifier 12 is also coupled with a tuner deck 15. When the tuner deck 15 plays music stored in a music memory medium, or when the tuner deck 15 receives a radio program from a radio broadcasting station, the audio amplifier 12 amplifies a signal of the music or the radio program, and then, the amplified signal is output from the speakers 13, 14.

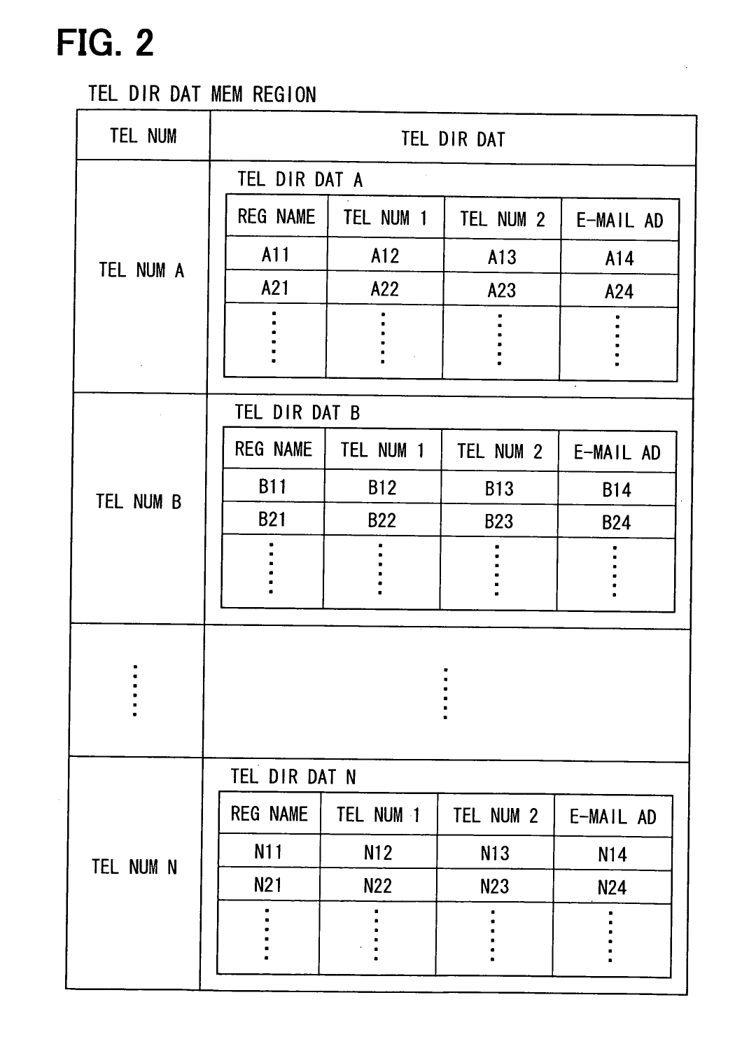

The memory 7 has a memory region, which is capable of storing various data. The telephone directory data is stored in a telephone directory data memory region. As shown in FIG. 2, the telephone directory data memory region includes multiple memory regions, each of which stores a telephone directory data corresponding to a telephone number. In FIG. 2, the memory regions store data corresponding to the telephone number A, the telephone number B, . . . , and the telephone number N. The data include the telephone directory data A, the telephone directory data B . . . , and the telephone directory data N. The number of data of the telephone number, which is capable of being stored in the memory 7, corresponds to the number of cell phones 3, which is capable of being coupled with the interface 5 via the BT communication line. For example, the memory 7 can store a few data of the telephone number, and the interface 5 can be coupled with a few cell phones 3. Each telephone directory data includes multiple registered name data, multiple first telephone number data, multiple second telephone number data, and multiple e-mail address data. One registered name data, one first telephone number data, one second telephone number data, and one e-mail address data provide one set of data. Thus, each directory data provides a data group having a predetermined number of sets of data such as one hundred sets of data. The registered name data shown as A11, A21, B11, B21, N11, N21 provides a personal name. The first and second telephone number data shown as A12, A13, A22, A23, B12, B13, B22, B23, N12, N13, N22, N23 provide numerals having predetermined digits. The e-mail address data shown as A14, A24, B14, B24, N14, N24 provides a letter string such as English letters and numerals.

In the above case, one set of data represents one registered name, one first telephone number, one second telephone number and one e-mail address. Alternatively, one set of data may represent one registered name, equal to or more than three telephone numbers, and/or two or more e-mail addresses. In this case, the user can utilize the telephone directory data, i.e., the user selects the registered name without inputting directly the telephone number so that the user easily and rapidly calls a person corresponding to the registered name.

The memory 7 includes the telephone directory data memory region for storing the telephone directory data. Further, the memory 7 includes an outgoing call history data memory region and an incoming call history data memory region. In the outgoing call history data memory region, outgoing call history data is stored. The outgoing call history data shows a relationship between time, at which the hands-free device 2 or the cell phone 3 calls, and a telephone number of the other side, to which the hands-free device 2 or the cell phone 3 calls. The time provides outgoing time, and the telephone number provides outgoing telephone number, which relate to outgoing call operation from the in-vehicle hands-free device 2 or outgoing call operation from the cell phone 3, which is coupled with the hands-free device 2 in the HFP. In the incoming call history data memory region, incoming call history data is stored. The incoming call history data shows a relationship between time, at which the cell phone 3 receives a call, and a telephone number of the other side, from which the cell phone 3 receives a call. The time provides incoming time, and the telephone number provides incoming telephone number, which relate to incoming call operation from the cell phone 3, which is coupled with the hands-free device 2 in the HFP.

The signal input element 10 receives an accessory (ACC) signal from a key switch so that the element 10 inputs the ACC signal into the device 2. When the ACC signal is in a high level, i.e., the signal shows a switch-on, the controller 4 controls the device 2 to be in a power on state so that electric power from an in-vehicle battery is supplied to all parts of the device 2. Thus, the device 2 is operated in an ordinary mode, i.e., the device 2 functions in a wake-up state. When the ACC signal is in a low level, i.e., the signal shows a switch-off, the controller 4 controls the device 2 to be in a power off state so that the electric power from the in-vehicle battery is supplied to limited parts of the device 2. Thus, the device 2 is operated in a low electric power consumption mode, i.e., the device 2 functions in a sleep state.

The display device 16 includes a display screen 17 and a touch operation input element 18. The display screen 17 display various screen images. The touch operation input element 18 provides a touch switch on the screen image. When the display instruction notice is input into the display controller 8 from the controller 4, the display controller 8 controls display operation of the display screen 17 based on the display instruction notice. When the user touches the touch switch 18 on the screen image so that the operation detection notice is input into the touch operation input element 9 from the touch switch 18, the operation detection notice is output from the touch operation input element 9 to the controller 4. The controller 4 analyzes the operation detection notice input from the touch operation input element 9.

The cell phone 3 includes a control portion, a communication portion, a BT interface portion, a key input portion, a memory portion, a display portion, a microphone, and a speaker. The control portion controls operation of the cell phone 3. The communication portion performs communication with a communication network 19. The BT interface portion performs the BT communication. The key input portion has various keys, which are arranged in a predetermined manner so that the user operates the key. The memory portion includes a telephone directory data memory region for storing the telephone directory data, an outgoing call history data memory region for storing outgoing call history data, and an incoming call history data memory region for storing incoming call history data. The display portion displays various screen images. The microphone inputs voice from the user. The speaker outputs voice from the other side when the cell phone 3 receives a signal of the voice from the other side.

In this case, the BT interface portion of the cell phone 3 has the BT communication function with the hands-free device 2. Specifically, the BT interface portion of the cell phone 3 is coupled with the BT interface 5 of the hands-free device 2 with using the HFP and the PBAP. The communication network 19 includes facilities such as cell phone station and a controller in the station for providing cell phone services. Although the HFP and the PBAP are performed between the hands-free device 2 and the cell phone 3, a message access profile (i.e., MAP) may be performed between the device 2 and the phone 3. The MAP performs transfer of a e-mail. Here, the e-mail provides a literal message and/or image information, which are exchanged via the computer network.

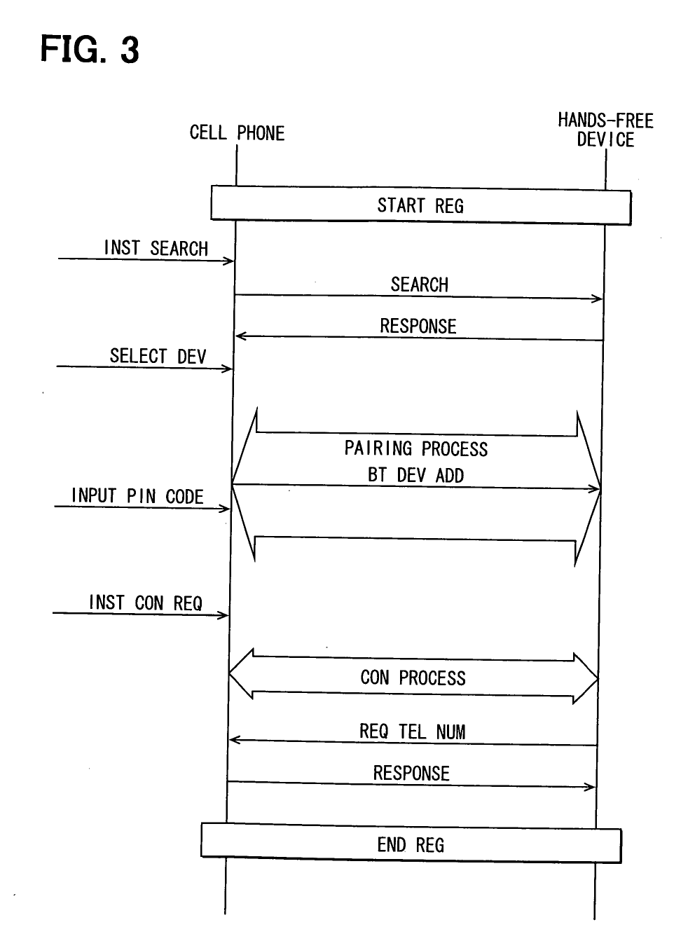

The user operates the key input portion of the cell phone 3 so that the cell phone is registered as the other side of connection with the hands-free device 2. A step of registering the cell phone 3 as the other side of the connection with the device 2 will be explained with reference to FIG. 3.

When the user operates the key input portion of the cell phone 3 in order to instruct a connection device search operation, the cell phone 3 transmits a search signal so that the connection device for coupling with the cell phone via the BT communication line is searched. Since the hands-free device 2 is disposed in a BT communication area, in which the cell phone 3 is coupled with the BT communication, the hands-free device 2 receives the search signal from the cell phone 3. Then, the hands-free device 2 transmits a response signal of the search signal. When the cell phone 3 receives the response signal from the hands-free device 2, the cell phone 3 notices the user that the connection device is searched. Multiple connection devices may be successively searched.

When the user operates the key input portion of the cell phone 3 so that the user selects an object device to be coupled with the cell phone 3 among connection devices, which are successively searched, the cell phone 3 starts to execute a pairing process for the hands-free device 2, which is a transmission source of the search response. In this case, the cell phone 3 transmits the BT device address to the hands-free device 2.

Next, when the user operates the key input portion, a PIN code is input into the cell phone 3. After the pairing process ends, the user operates the key input portion so that the user instructs connection request. Then, the cell phone 3 starts to execute a connection process for connecting to the hands-free device 2. After the connection process ends so that the hands-free device 2 is coupled with the hands-free device 2, the hands-free device 2 transmits a signal for requesting the telephone number of the cell phone 3 to the cell phone 3. When the cell phone 3 receives the signal from the hands-free device 2, the cell phone 3 transmits a response signal showing information including the telephone number of the cell phone 3. When the hands-free device 2 receives the response signal from the cell phone 3, a registration procedure for registering the cell phone 3 as the connection device ends.

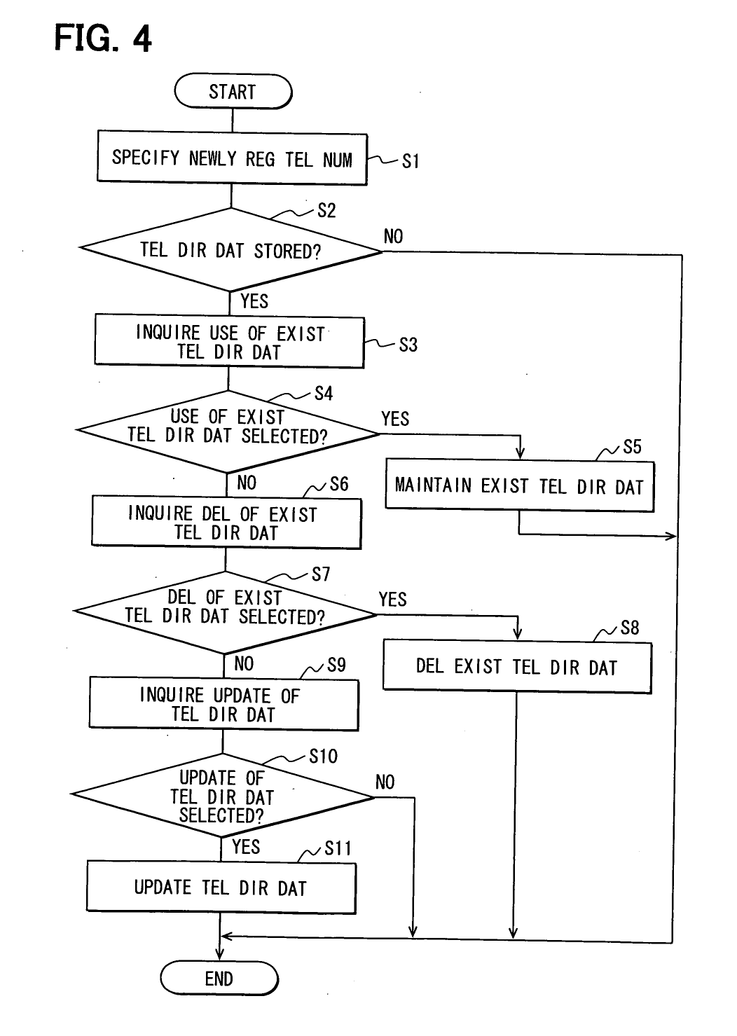

Next, operation results will be explained with reference to FIGS. 4 to 7. Here, assuming that a model of the cell phone is replaced to a new model, i.e., when the cell phone is replaced with a new one although a service contract and a telephone number are not changed, the operation results will be explained. In this case, the user registers the new cell phone 3 as the connection device. After the hands-free device 2 completes the registration procedure of the cell phone 3 as the connection device, as shown in FIG. 3, the hands-free device 2 executes a telephone directory data management process for managing the telephone directory data stored in the telephone directory data memory region of the memory 7. FIG. 4 shows a flowchart of the telephone directory data management process.

When the hands-free device 2 starts to execute the telephone directory. data management process, in step S1, the controller 4 specifies, i.e., identifies the telephone number of the cell phone 3, which is newly registered in the device 2, and obtained in the registration procedure for registering the cell phone 3 as the connection device. Then, in step S2, the controller 4 determines whether the telephone directory data corresponding to the telephone number of the newly registered cell phone 3 is stored in the telephone directory data memory region of the memory 7. Here, the telephone directory data corresponding to the telephone number of the newly registered model cell phone 3 is equal to the telephone directory data corresponding to the telephone number of the previously registered model cell phone 3. Specifically, the telephone directory data corresponding to the telephone number of the previously registered model cell phone 3 is used before the model of the cell phone 3 is replaced to the new one.

When the telephone directory data corresponding to the previous cell phone 3, which was used before replacement of the new model of the cell phone 3, is not stored in the telephone directory data memory region of the memory 7, the telephone directory data corresponding to the new cell phone 3 is not stored in the telephone directory data memory region of the memory 7 since the telephone number of the previous cell phone 3 is equal to the telephone number of the new cell phone 3. When the controller 4 determines that the telephone directory data corresponding to the telephone number of the new cell phone 3 is not stored in the telephone directory data memory region of the memory 7, i.e., the determination in step S2 is “NO,” the telephone directory data management process ends.

When the telephone directory data corresponding to the previous cell phone 3, which was used before replacement of the new model of the cell phone 3, is stored in the telephone directory data memory region of the memory 7, the telephone directory data corresponding to the new cell phone 3 is stored in the telephone directory data memory region of the memory 7 since the telephone number of the previous cell phone 3 is equal to the telephone number of the new cell phone 3. When the controller 4 determines that the telephone directory data corresponding to the telephone number of the new cell phone 3 is stored in the telephone directory data memory, region of the memory 7, i.e., the determination in step S2 is “YES,” it goes to step S3. In step S3, display guidance for inquiring of the user whether the user utilizes the existing telephone directory data is displayed on the display device 17. Specifically, the message of “Do you utilize the existing telephone directory data?” is displayed on the display device 17. Further, in step S3, a button “YES” and a button “NO” are displayed as a touch button on the display screen so that the user selects whether the user utilizes the existing telephone directory data. In step S4, the controller 4 waits for selection of the user. In this case, when the user utilizes the existing telephone directory data, the user pushes or touches the button “YES.” When the user does not utilize the existing telephone directory data, the user pushes or touches the button “NO.”

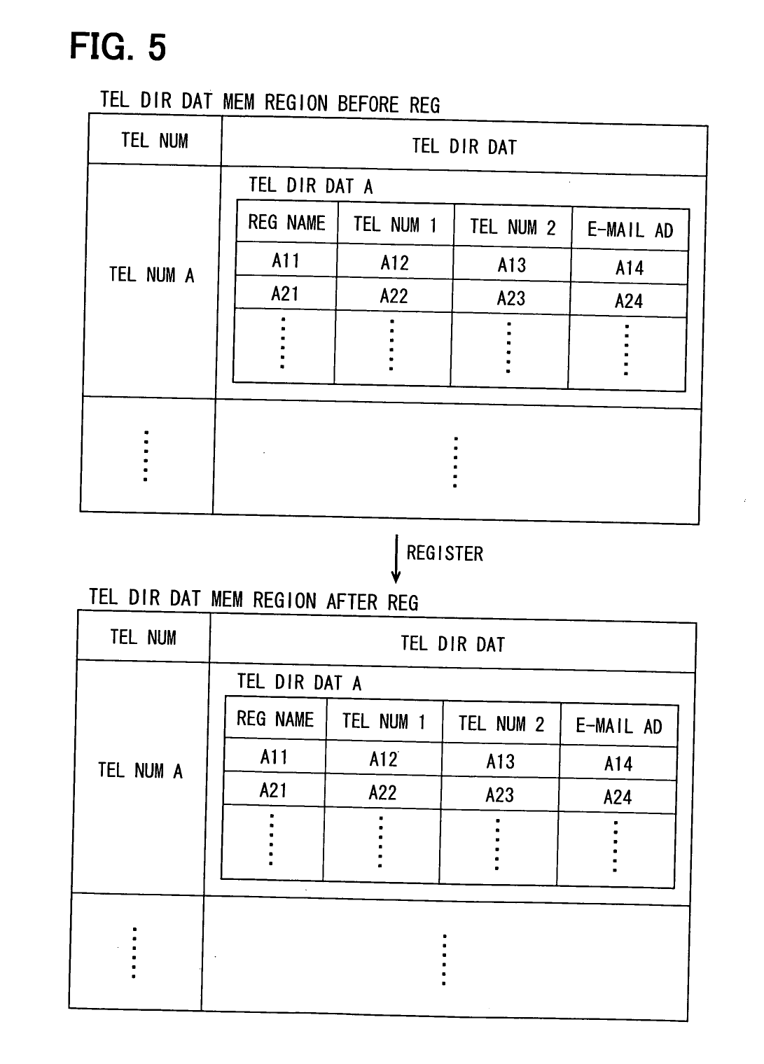

When the user operates the button “YES,” i.e., when the user performs a first predetermined operation, so that the user selects to utilize the existing telephone directory data, it goes to step S5. Specifically, the determination in step S4 is “YES,” it goes to step S5. In step S5, the existing telephone directory data stored in the telephone directory data memory region of the memory 7 and corresponding to the telephone number of the cell phone 3 before the model of the cell phone 3 is changed is maintained without changing. Further, correspondence relationship between the telephone number and the telephone directory data stored in the memory 7 before the cell phone 3 is replaced to the new one is maintained without changing. Thus, as shown in FIG. 5, when the user changes the model of the cell phone 3 having the telephone number A, the controller 4 maintains a memory state in the telephone directory data memory region such that the telephone directory data A as the existing telephone directory data corresponding to the telephone number A is stored. Thus, the correspondence relationship between the telephone number A and the telephone directory data A is not changed even after the new cell phone 3 is registered.

When the user operates the button “NO” so that the user selects not to utilize the existing telephone directory data, it goes to step S6. Specifically, the determination in step S4 is “NO,” it goes to step S6. In step S6, display guidance for inquiring of the user whether the user deletes the existing telephone directory data is displayed on the display device 17. Specifically, the message of “Do you delete the existing telephone directory data?” is displayed on the display device 17. Further, in step S6, a button “YES” and a button “NO” are displayed as a touch button on the display screen so that the user selects whether the user deletes the existing telephone directory data. In step S7, the controller 4 waits for selection of the user. In this case, when the user deletes the existing telephone directory data, the user pushes or touches the button “YES.” When the user does not delete the existing telephone directory data, the user pushes or touches the button “NO.”

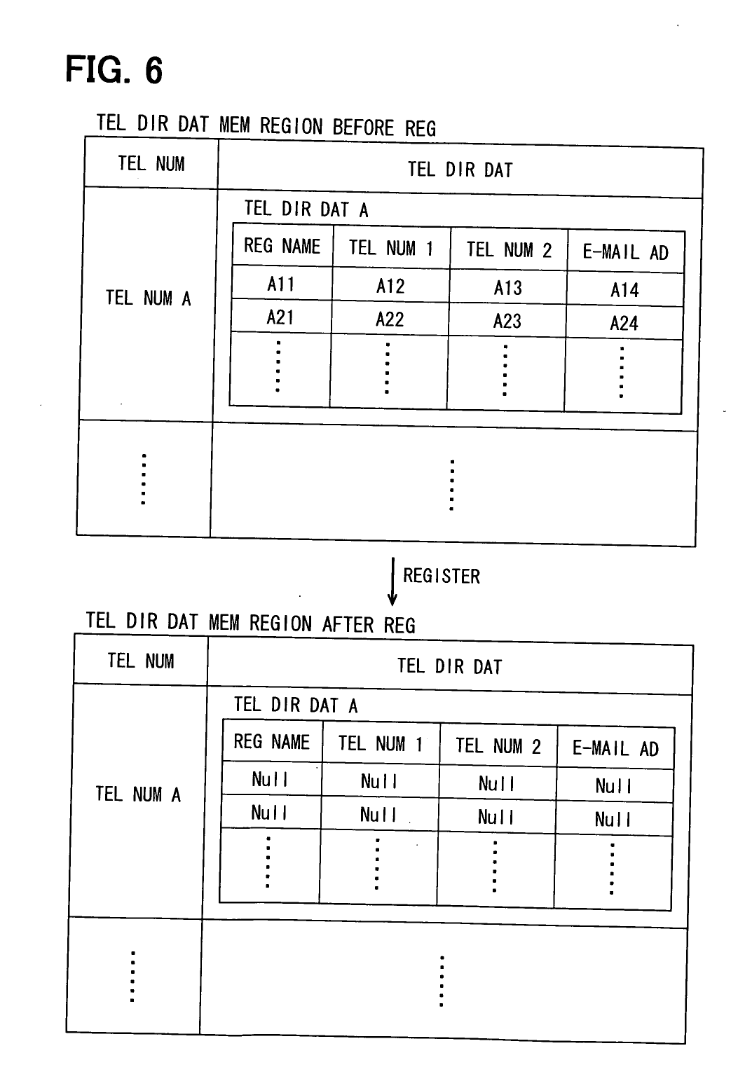

When the user operates the button “YES,” i.e., when the user performs a second predetermined operation, so that the user selects to delete the existing telephone directory data, it goes to step S8. Specifically, the determination in step S7 is “YES,” it goes to step S8. In step S8, the existing telephone directory data stored in the telephone directory data memory region of the memory 7 and corresponding to the telephone number of the cell phone 3 before the model of the cell phone 3 is changed is deleted. Thus, as shown in FIG. 6, when the user changes the model of the cell phone 3 having the telephone number A, the controller 4 deletes a memory state in the telephone directory data memory region such that the telephone directory data A as the existing telephone directory data corresponding to the telephone number A is stored. Thus, the telephone directory data A corresponding to the telephone number A is deleted after the new cell phone 3 is registered. Here, the term “Null” in FIG. 6 shows that the data does not exist, i.e., the data is deleted.

When the user operates the button “NO” so that the user selects not to delete the existing telephone directory data, it goes to step S9. Specifically, the determination in step S7 is “NO,” it goes to step S9. In step S9, display guidance for inquiring of the user whether the user updates the existing telephone directory data with a new telephone directory data is displayed on the display device 17. Specifically, the message of “Do you update the existing telephone directory data with a new telephone directory data?” is displayed on the display device 17. Further, in step S9, a button “YES” and a button “NO” are displayed as a touch button on the display screen so that the user selects whether the user update the existing telephone directory data with the new telephone directory data. In step S10, the controller 4 waits for selection of the user. In this case, when the user updates the existing telephone directory data with the new telephone directory data, the user pushes or touches the button “YES.” When the user does not update the existing telephone directory data with the new telephone directory data, the user pushes or touches the button “NO.”

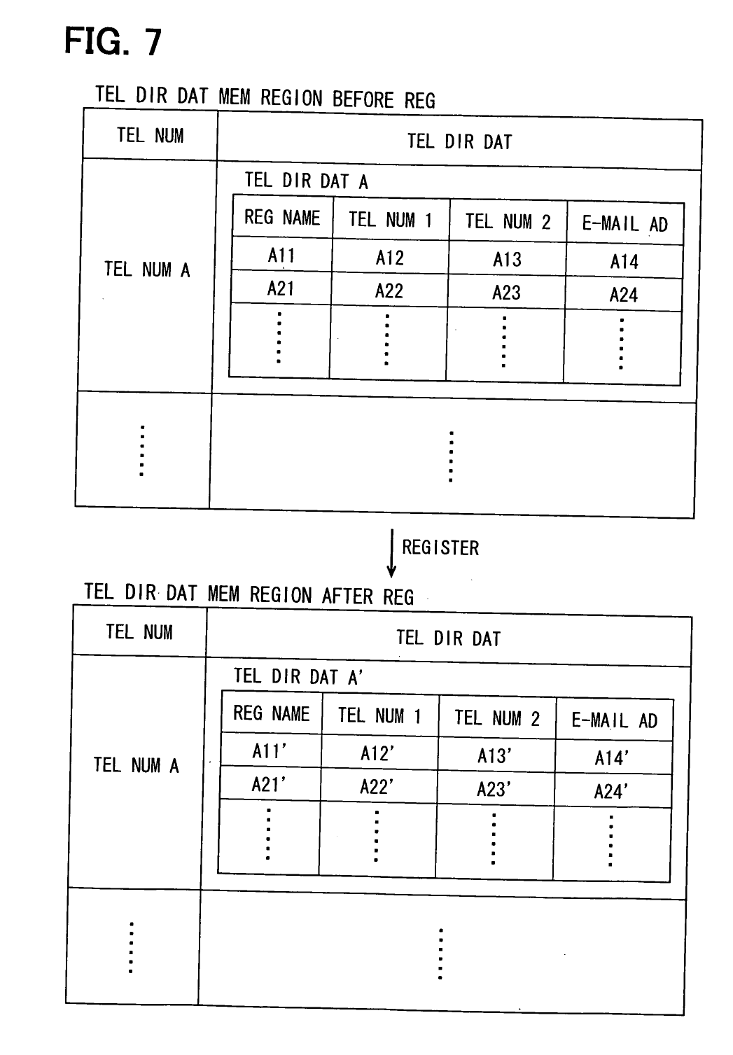

When the user operates the button “YES,” i.e., when the user performs a third predetermined operation, so that the user selects to update the existing telephone directory data with the new telephone directory data, it goes to step S11. Specifically, the determination in step S10 is “YES,” it goes to step S11. In step S11, the hands-free device 2 transmits a request signal for requesting transmission of the telephone directory data to the newly registered cell phone 3 so that the telephone directory data stored in the newly registered cell phone 3 is transmitted to the hands-free device 2 from the cell phone 3. Thus, the previous telephone directory data stored in the telephone directory data memory region of the memory 7 is updated with the telephone directory data, which is transmitted from the newly registered cell phone 3. Thus, as shown in FIG. 7, when the user changes the model of the cell phone 3 having the telephone number A, the controller 4 updates a memory state in the telephone directory data memory region such that the telephone directory data A as the existing telephone directory data corresponding to the telephone number. A is stored. Thus, the telephone directory data A corresponding to the telephone number A is updated with the telephone directory data A′ corresponding to the telephone number A and transmitted from the newly registered cell phone 3 after the new cell phone 3 is registered. Here, the telephone directory data A′ is different from the telephone directory data A. Specifically, the contents of the telephone directory data A′ are different from the contents of the telephone directory data A.

Thus, in the present embodiment, the hands-free device 2 connects the telephone number and the telephone directory data, and manages the correspondence relationship between the telephone number and the telephone directory data in the telephone directory data memory region of the memory 7. When the user changes the model of the cell phone 3, and registers the new cell phone 3, the correspondence relationship between the telephone number and the telephone directory data is maintained in a case where the telephone directory data corresponding to the telephone number of the new cell phone that is equal to the telephone number of the previous cell phone is stored in the memory 7, and further, the user selects to utilize the existing telephone directory data. Thus, even when the user changes the model of the cell phone 3, the telephone directory data that is usable before the user changes the model is continuously usable after the user changes the model.

When the user selects to delete the existing telephone directory data, the hands-free device 2 deletes the existing telephone directory data. Thus, when the user changes the model of the cell phone 3, the telephone directory. data, which has been used before the user changes the model, is deleted. Further, when the user selects to update the existing telephone directory data with the new telephone directory data, the existing telephone directory data is updated with the new telephone directory data, which is transmitted from the new cell phone ^{.}3 after the user changes the model of the cell phone 3. Thus, when the user changes the model of the cell phone 3, the existing telephone directory data is updated with the new telephone directory data.

In the above embodiment, the telephone directory data memory device having near field wireless communication function is the in-vehicle hands-free device having the hands-free function. Alternatively, the telephone directory data memory device having near field wireless communication function may be an in-vehicle navigation device or other in-vehicle devices as long as the device has a memory function for storing the telephone directory data. Alternatively, the telephone directory data memory device having near field wireless communication function may be a mobile device, which the user can carry.

The above disclosure has the following aspects.

According to a first aspect of the present disclosure, a telephone directory data memory device having a near field wireless communication function includes: a communication line connecting element for coupling with a cell phone via a near field wireless communication line, wherein the cell phone stores a telephone directory data; a memory for storing the telephone directory data, which is transmitted from the cell phone; a controller for controlling a memory status of the telephone directory data in the memory; and a telephone number obtaining element for obtaining a new telephone number of a new cell phone when the new cell phone is registered as a connection object device of the communication line connecting element. The new telephone number of the new cell phone is equal to a telephone number of the cell phone. The memory connects the telephone number of the cell phone and the telephone directory data, and stores a correspondence relationship between the telephone number and the telephone directory data. The controller controls the memory to maintain the correspondence relationship between the telephone number and the telephone directory data when a first predetermined condition is met in a case where the telephone directory data corresponding to the telephone number is stored in the memory.

Although a conventional device manages a correspondence relationship between a BT device address and a telephone directory data, the above device manages the correspondence relationship between the telephone number and the telephone directory data. Thus, even when the user changes a model of the cell phone, the telephone directory data that is available before the model is changed is continuously available after the model is changed.

Alternatively, the telephone directory data memory device may further include: a first operation input element for receiving a first operation of a user. The controller determines that the first predetermined condition is met when the first operation input element receives the first operation of the user. In this case, the user can select whether the first operation is performed.

Alternatively, the controller may control the memory to delete the telephone directory data when a second predetermined condition is met in a case where the telephone directory data corresponding to the telephone number is stored in the memory. In this case, the telephone directory data that is available before the model is changed is deleted.

Alternatively, the telephone directory data memory device may further include: a second operation input element for receiving a second operation of the user. The controller determines that the second predetermined condition is met when the second operation input element receives the second operation of the user.

Alternatively, the telephone directory data memory device may further include: a telephone directory data obtaining element for obtaining a new telephone directory data stored in the new cell phone. The controller controls the memory to update the telephone directory data with the new telephone directory data when a third predetermined condition is met in a case where the telephone directory data corresponding to the telephone number is stored in the memory. Further, the telephone directory data memory device may further include: a third operation input element for receiving a third operation of the user. The controller determines that the third predetermined condition is met when the third operation input element receives the third operation of the user.

Alternatively, the telephone directory data memory device may be an in-vehicle hands-free device having a hands-free communication function or an in-vehicle navigation device having a hands-free communication function.

According to a second aspect of the present disclosure, a method for managing a telephone directory data in a memory device having a near field wireless communication function includes: searching a cell phone having a near field wireless communication function around the memory device; connecting the memory device and the cell phone via a near field wireless communication line; obtaining a telephone number and a telephone directory data stored in the cell phone, and storing a correspondence relationship between the telephone number and the telephone directory data in the memory device; inquiring of an user of the memory device whether the telephone directory data is available when a new cell phone is searched, and the telephone directory data corresponding to a new telephone number of the new cell phone is stored in the memory device; and maintaining the correspondence relationship between the new telephone number and the telephone directory data when the user selects that the telephone directory data is available.

Although a conventional device manages a correspondence relationship between a BT device address and a telephone directory data, the above device manages the correspondence relationship between the telephone number and the telephone directory data. Thus, even when the user changes a model of the cell phone, the telephone directory data that is available before the model is changed is continuously available after the model is changed.

Alternatively, the method for managing the telephone directory data may further include: inquiring of the user of the memory device whether the telephone directory data is deleted when the user selects that the telephone directory data is not available; and deleting the telephone directory data when the user selects that the telephone directory data is deleted. Further, the method for managing the telephone directory data may further include: inquiring of the user of the memory device whether the telephone directory data is updated when the user selects that the telephone directory data is not deleted; and updating the telephone directory data with a new telephone directory data of the new cell phone when the user selects that the telephone directory data is updated.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A telephone directory data memory device having a near field wireless communication function comprising:
a communication line connecting element for coupling with a cell phone via a near field wireless communication line, wherein the cell phone stores a telephone directory data;
a memory for storing the telephone directory data, which is transmitted from the cell phone;
a controller for controlling a memory status of the telephone directory data in the memory; and
a telephone number obtaining element for obtaining a new telephone number of a new cell phone when the new cell phone is registered as a connection object device of the communication line connecting element,
wherein the new telephone number of the new cell phone is equal to a telephone number of the cell phone,
wherein the memory connects the telephone number of the cell phone and the telephone directory data, and stores a correspondence relationship between the telephone number and the telephone directory data, and
wherein the controller controls the memory to maintain the correspondence relationship between the telephone number and the telephone directory data when a first predetermined condition is met in a case where the telephone directory data corresponding to the telephone number is stored in the memory.

2. The telephone directory data memory device according to claim 1, further comprising:
a first operation input element for receiving a first operation of an user,
wherein the controller determines that the first predetermined condition is met when the first operation input element receives the first operation of the user.

3. The telephone directory data memory device according to claim 1,
wherein the controller controls the memory to delete, the telephone directory data when a second predetermined condition is met in a case where the telephone directory data corresponding to the telephone number is stored in the memory.

4. The telephone directory data memory device according to claim 3, further comprising:
a second operation input element for receiving a second operation of the user,
wherein the controller determines that the second predetermined condition is met when the second operation input element receives the second operation of the user.

5. The telephone directory data memory device according to claim 1, further comprising:
a telephone directory data obtaining element for obtaining a new telephone directory data stored in the new cell phone,
wherein the controller controls the memory to update the telephone directory data with the new telephone directory data when a third predetermined condition is met in a case where the telephone directory data corresponding to the telephone number is stored in the memory.

6. The telephone directory data memory device according to claim 5, further comprising:
a third operation input element for receiving a third operation of the user,
wherein the controller determines that the third predetermined condition is met when the third operation input element receives the third operation of the user.

7. The telephone directory data memory device according to claim 1,
wherein the telephone directory data memory device is an in-vehicle hands-free device having a hands-free communication function or an in-vehicle navigation device having a hands-free communication function.

8. A method for managing a telephone directory data in a memory device having a near field wireless communication function comprising:
searching a cell phone having a near field wireless communication function around the memory device;
connecting the memory device and the cell phone via a near field wireless communication line;
obtaining a telephone number and a telephone directory data stored in the cell phone, and storing a correspondence relationship between the telephone number and the telephone directory data in the memory device;
inquiring of an user of the memory device whether the telephone directory data is available when a new cell phone is searched, and the telephone directory data corresponding to a new telephone number of the new cell phone is stored in the memory device; and
maintaining the correspondence relationship between the new telephone number and the telephone directory data when the user selects that the telephone directory data is available.

9. The method for managing the telephone directory data according to claim 8, further comprising:
inquiring of the user of the memory device whether the telephone directory data is deleted when the user selects that the telephone directory data is not available; and
deleting the telephone directory data when the user selects that the telephone directory data is deleted.

10. The method for managing the telephone directory data according to claim 9, further comprising:
inquiring of the user of the memory device whether the telephone directory data is updated when the user selects that the telephone directory data is not deleted; and
updating the telephone directory data with a new telephone directory data of the new cell phone when the user selects that the telephone directory data is updated.
